(19) United States
(12) Patent Application Publication
(10) Pub. No.: US 2025/0058878 A1
(43) Pub. Date: Feb. 20, 2025

(54) SYSTEM AND METHOD FOR STORAGE

(71) Applicant: Textron Aviation, Inc., Wichita, KS (US)

(72) Inventors: Matthew William Reese, Wichita, KS (US); Jason Michael Decker, Wichita, KS (US); Adam Ryan Payton, Haysville, KS (US)

(21) Appl. No.: 18/449,124

(22) Filed: Aug. 14, 2023

(51) Int. Cl. B64D 11/06; B64D 11/00

(52) U.S. Cl. CPC B64D 11/0636; B64D 11/003

(57) ABSTRACT

A system for storage includes a drawer configured to open with a push, a drawer base, and a seat. A drawer face of the drawer is free of a handle. The drawer opens in a first direction along two or more slides. The drawer base is under the drawer, the drawer being coupled to the drawer base. The seat is over the drawer. The seat faces perpendicular to the first direction.

### TECHNICAL FIELD

Embodiments of this disclosure relates generally to a system and method for underseat storage, and, in particular embodiments, to a system and method for storage under aircraft passenger seats.

### BACKGROUND

In private and commercial aviation, passenger comfort and convenience are important factors in determining the overall travel experience. One aspect that significantly contributes to passenger satisfaction is the availability of efficient storage space within the aircraft cabin. The storage facilities on passenger aircraft play a vital role in accommodating personal belongings, carry-on luggage, and other essential items that passengers desire to have readily accessible during their flight. Although traditional storage solutions on aircraft have included overhead compartments and under-seat spaces, it is desirable to develop innovative and improved cabin storage systems for increased passenger convenience and access.

### SUMMARY

In accordance with an embodiment, a system for storage includes: a passenger seat, the passenger seat being coupled to a floor of an aircraft; a drawer under the passenger seat, the drawer being configured to open perpendicular to a front side of the passenger seat; and a light coupled to a base of the passenger seat, the light being above the drawer, the light being configured to illuminate an interior of the drawer at a first brightness when the drawer is in an open state and to provide aisle lighting at a second brightness when the drawer is in a closed state, the second brightness being less than the first brightness.

In accordance with another embodiment, a system for underseat storage includes: a drawer, the drawer being configured to open with a push, a drawer face of the drawer being free of a handle, the drawer opening in a first direction along two or more slides; a drawer base under the drawer, the drawer being coupled to the drawer base; and an aircraft seat over the drawer, where the aircraft seat faces perpendicular to the first direction, the drawer base being coupled to feet of the aircraft seat.

In accordance with yet another embodiment, a method for storage includes: pushing on a drawer face of a drawer, the drawer being under a passenger seat, the pushing releasing a latch; opening the drawer, where opening the drawer activates a white light coupled to a seat base of the passenger seat, the white light being positioned to illuminate the opened drawer; and closing the drawer, where closing the drawer deactivates the white light.

It is to be understood that both the foregoing general description and the following detailed description are exemplary and explanatory only and are not restrictive of the disclosure, as claimed.

### BRIEF DESCRIPTION OF THE DRAWINGS

For a more complete understanding of the present invention, and the advantages thereof, reference is now made to the following descriptions taken in conjunction with the accompanying drawings, in which:

FIGS. 1A, 1B, 1C, 1D, and 1E illustrate various views of a seat system with a closed drawer, in accordance with some embodiments;

FIGS. 2A, 2B, and 2C illustrate various views of a drawer, in accordance with some embodiments;

FIGS. 3A, 3B, 3C, 3D, 3E, and 3F illustrate various views of a drawer, in accordance with some embodiments;

FIGS. 4A, 4B, 4C, and 4D illustrate various views of a drawer, in accordance with some embodiments;

FIGS. 5A, 5B, 5C, and 5D illustrate various views of a drawer, in accordance with some embodiments; and

FIG. 6 illustrates a flow chart diagram of a method for storage, in accordance with some embodiments.

Corresponding numerals and symbols in the different figures generally refer to corresponding parts unless otherwise indicated. The figures are drawn to clearly illustrate the relevant aspects of the embodiments and are not necessarily drawn to scale. The edges of features drawn in the figures do not necessarily indicate the termination of the extent of the feature.

### DETAILED DESCRIPTION OF ILLUSTRATIVE EMBODIMENTS

The making and using of various embodiments are discussed in detail below. It should be appreciated, however, that the various embodiments described herein are applicable in a wide variety of specific contexts. The specific embodiments discussed are merely illustrative of specific ways to make and use various embodiments, and should not be construed in a limited scope.

Reference to “an embodiment” or “one embodiment” in the framework of the present description is intended to indicate that a particular configuration, structure, or characteristic described in relation to the embodiment is included in at least one embodiment. Hence, phrases such as “in an embodiment” or “in one embodiment” that may be present in one or more points of the present description do not necessarily refer to one and the same embodiment. Moreover, particular conformations, structures, or characteristics may be combined in any adequate way in one or more embodiments. The references used herein are provided merely for convenience and hence do not define the extent of protection or the scope of the embodiments.

According to one or more embodiments of the present disclosure, this application relates to a system and method for storage under seats (for example, under aircraft passenger seats). A drawer is located under a seat and may be used for underseat storage. The drawer is opened by a push-to-release latch. The use of a push-to-release latch allows the face of the drawer to be decorative due to the absence of a latch release handle. A light installed in the seat base is positioned to provide aisle lighting when the drawer is closed and to illuminate the contents of the drawer when the drawer is opened. The light may display different colors when the drawer is closed and when the drawer is opened.

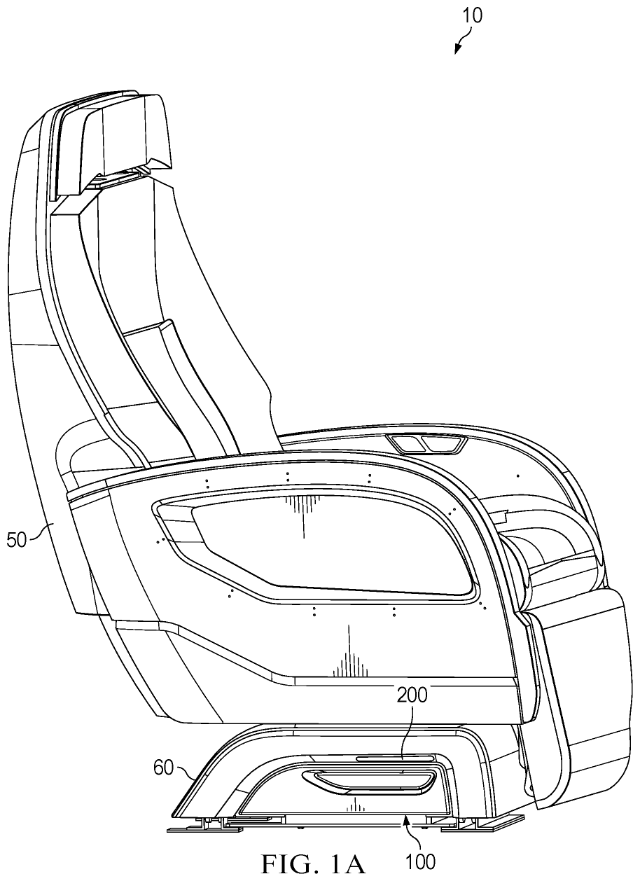

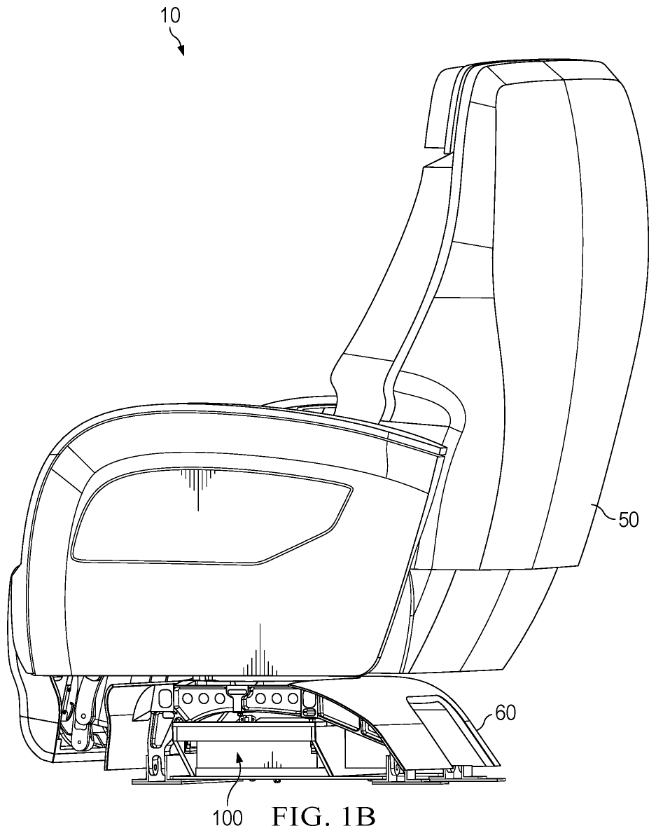

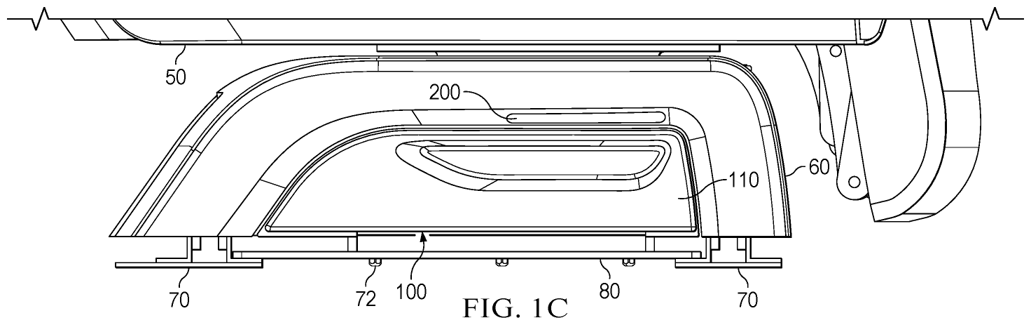

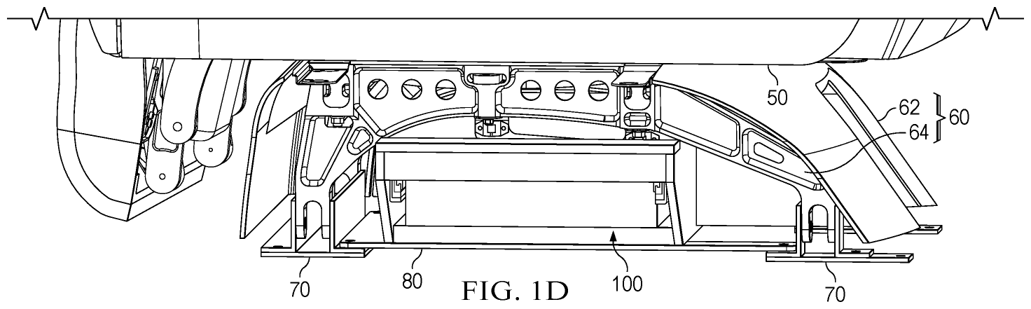

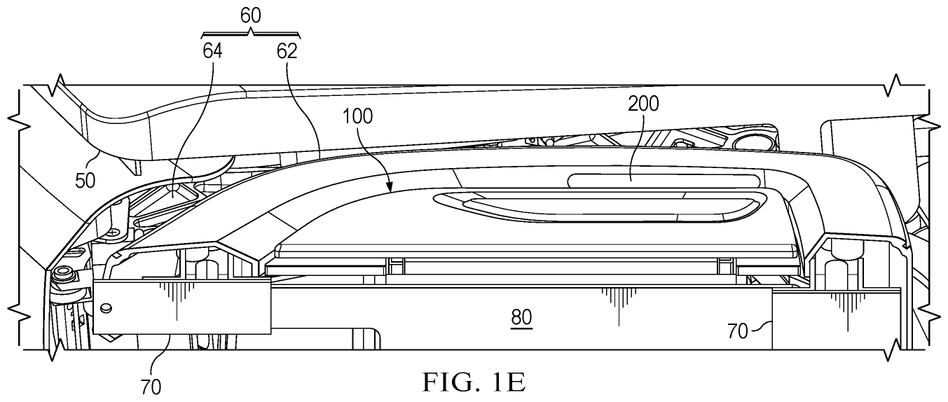

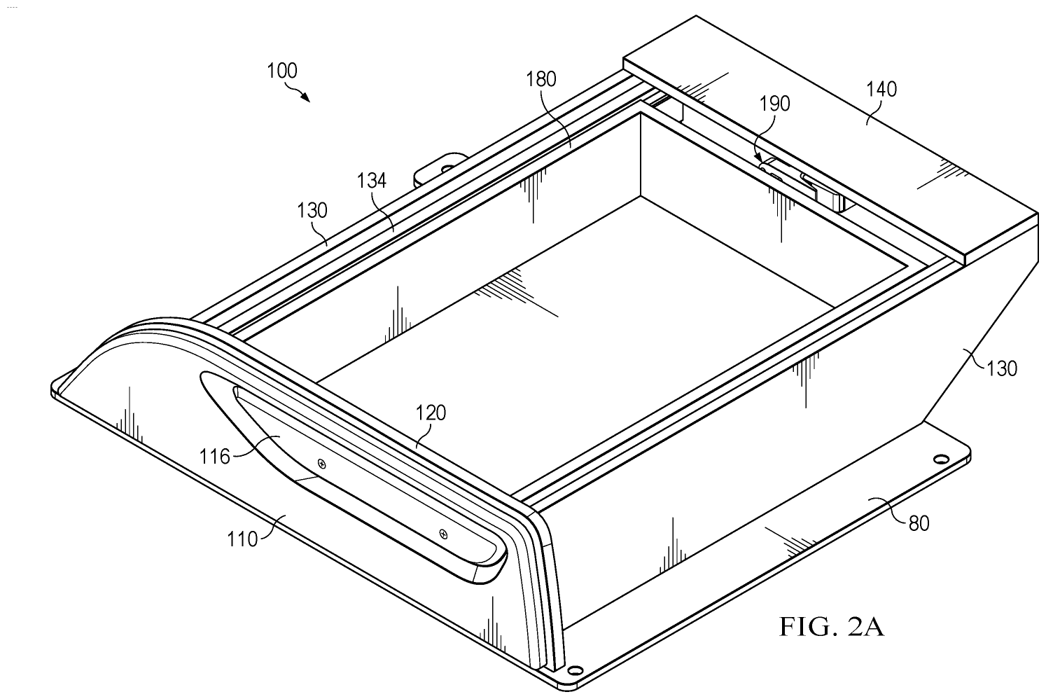

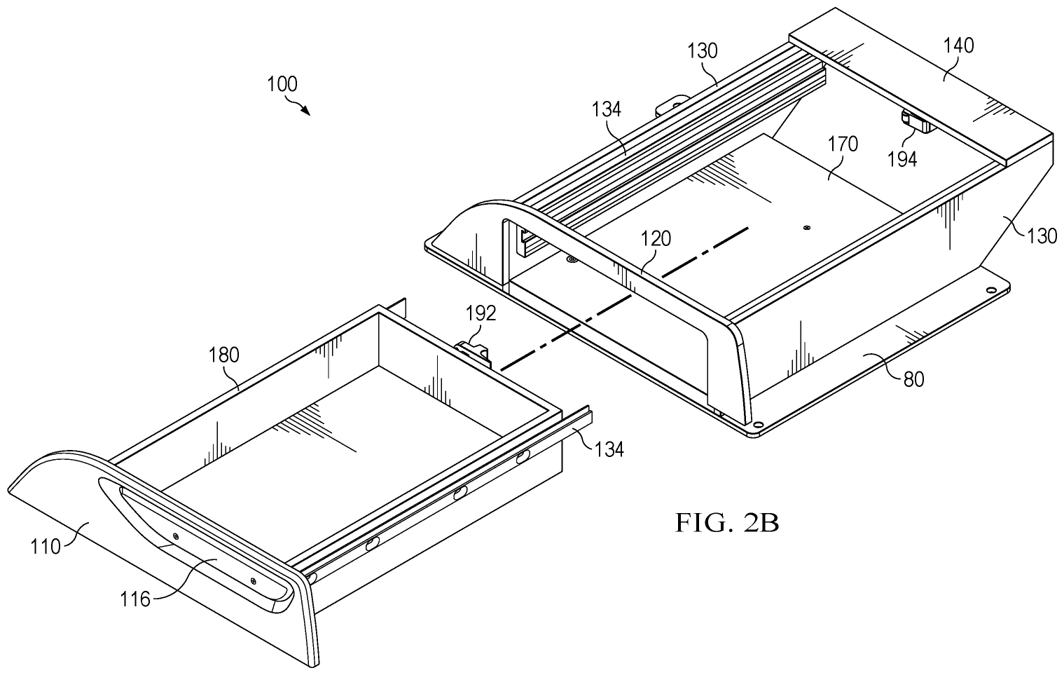

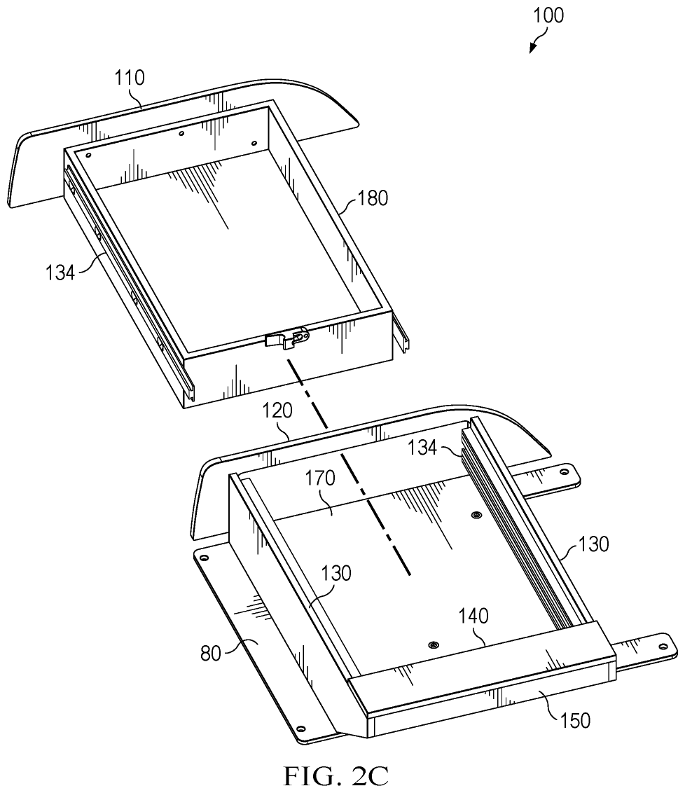

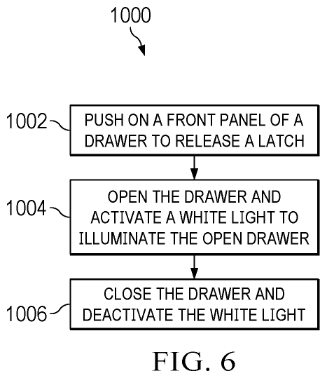

Embodiments of the disclosure are described in the context of the accompanying drawings. Embodiments of a seat system will be described using FIGS. 1A-1E. Embodiments of a drawer for under seat storage will be described using FIGS. 2A-2C, 3A-3F, 4A-4E, and 5A-5C. An embodiment of a method for storage will be described using FIG. 6.

FIGS. 1A-1E illustrate various views of a seat system 10 with a drawer 100 in a closed state, in accordance with some embodiments. FIG. 1A illustrates a perspective view of a right side of the seat system 10. The seat system 10 comprises a seat 50 (also referred to as a passenger seat, aircraft seat, or aircraft passenger seat), a seat base 60 (also referred to as a base of the passenger seat or a base of the seat), a drawer 100, and a light 200. In various embodiments, the seat system 10 is installed in a passenger aircraft. The seat system 10 may be installed in an aircraft cabin next to an aisle through the cabin, such as on the left side of the aisle. In some embodiments, the seat system 10 is installed on a small passenger aircraft as part of a single row of passenger seats (which may include other seat systems 10) on one or both sides of the aisle through the cabin. However, the seat system 10 may be installed in any suitable position on an aircraft, a wheeled vehicle, a boat, or in a building or other fixed construction.

The seat base 60 is coupled to a floor (e.g., a floor of an aircraft cabin adjacent to an aisle; not illustrated in FIG. 1A). In various embodiments, the seat base 60 comprises an arch profile with an irregular shape in a side view. As illustrated in FIG. 1A, the seat base 60 has a flattened top portion, a shortened forward portion under a front side of the seat 50, and a lengthened back portion under a back side of the seat 50. In some embodiments, the front portion of the seat base 60 is closer to vertical with respect to the floor than the back portion of the seat base 60, which forms a more acute angle with the floor than the front portion of the seat base 60. In some embodiments, the seat base 60 is a solid irregular arch. In other embodiments, the seat base 60 is a hollow irregular arch comprising one or more air-filled space(s) inside it and between one or more various support beam portions. The seat base 60 comprises one or more materials such as aircraft-grade aluminum, carbon fiber, plastic, the like, or a combination thereof. However, any suitable material may be used to form the seat base 60.

The seat 50 is coupled to a top surface of the seat base 60 with suitable fasteners such as screws, bolts, washers, nuts, the like, or a combination thereof. In various embodiments, the seat 50 accommodates a single person. However, the seat 50 may be constructed to be wide enough for two or more people. As illustrated in FIG. 1A, the seat 50 comprises a back portion, two armrest portions, and a footrest portion. The back portion may be reclined backwards and the footrest portion may be extended forwards, such as in a reclining mode of the seat system 10. In some embodiments, the seat 50 is coupled to the seat base 60 by a swivel mechanism that allows the seat 50 to be rotated with respect to the seat base 60, such as up to 360 degrees. However, the seat 50 may also be coupled to the seat base 60 in a fixed position (in other words, without a rotation mechanism).

The seat 50 comprises one or more materials such as aircraft-grade aluminum, carbon fiber, plastic, the like, or a combination thereof. However, any suitable material may be used to form the seat base 60. In some embodiments, the seat 50 comprises additional mechanisms for the convenience of a passenger sitting in the seat 50. The seat 50 may further comprise cushions or soft surfaces for the comfort of the passenger.

A drawer 100 is installed under the seat base 60. The drawer 100 may be used for storage, such as for personal items of a passenger in the aircraft in which the seating system 10 is installed. In various embodiments, the drawer 100 is opened by a push-to-release latch. In other words, pushing on a drawer face of the drawer 100 releases a latch and allows the drawer 100 to slide out from under the seat base 60. This transitions the drawer 100 from a closed state (covered by the seat base 60 with the latch secured) to an open state (protruding from under the seat base 60 with the latch not secured). The use of a push-to-release latch allows the face (in other words, the front panel) of the drawer 100 to be decorative (in other words, to display a decorative pattern or design) due to the absence of a latch release handle.

Although the seat system 10 is illustrated with the drawer 100 opening on a right side of the seat 50, in various embodiments the drawer 100 opens on a left side of the seat 50. This may be useful for seat systems 10 installed on a right side of an aisle in an aircraft cabin. In these embodiments, the seat system 10 is similar to illustrated embodiments with the drawer 100 opening on a right side of the seat 50 except with the drawer 100 facing and opening in the opposite direction. The drawer 100 and the seat base 60 may be similar with a symmetric flip across a midline of the seat system 10. It should be understood that the drawer 100 opening on a right side or on a left side of the seat system 10 are within the scope of the disclosed embodiments. In other words, in various embodiments the seat 50 faces in a first direction and the drawer 100 opens in a second direction perpendicular to the first direction. In some embodiments where the seat 50 swivels in multiple directions, the drawer 100 opens in a direction perpendicular to an aisle next to the seat system 10.

A light 200 is installed on a bottom face of the seat base 60 above the drawer 100. The light 200 is positioned to provide aisle lighting when the drawer 100 is in a closed state and to illuminate the interior of the drawer 100 (including any contents of the drawer 100) when the drawer 100 is in an open state. The light 200 may display different colors when the drawer 100 is closed and when the drawer 100 is opened.

In some embodiments, the light 200 comprises a colored light (e.g., a colored light-emitting diode (LED)) and a white light (e.g., a white LED, fluorescent light, or the like). The colored light may be any suitable color for illuminating an aisle of an aircraft cabin with main cabin lights off. For example, the colored light may be red, blue, violet, green, orange, yellow, a dimmer white, the like, or a combination thereof. The colored light has a first brightness (e.g., a brightness suitable for aisle illumination in an aircraft cabin with main cabin lights off), such as a brightness in a range of 50 lx (lumens per square meter) to 300 lx. The white light has a second brightness (e.g., a brightness suitable for illuminating the contents of the drawer 100 in an aircraft cabin with main cabin lights off), such as a brightness in a range of 250 lx to 1000 lx. In some embodiments, the second brightness of the white light is greater than the first brightness of the colored light so that the white light washes out the colored light when both the white light and the colored light are active.

In some embodiments, the colored light is configured to be on constantly (such as when the aircraft is active and passengers are present, regardless of whether the drawer 100 is in an open state or a closed state) and the white light is configured to be on only when the drawer 100 is in an open state. This may be achieved by coupling a switch to the drawer 100 that keeps the white light off when the drawer 100 is closed and turns the white light on when the drawer 100 is open. As such, the white light washes out the colored light when the drawer 100 is in an open state and the white light is on. In some embodiments, the switch is a pressure sensitive switch that is activated and deactivated by the pressure of the drawer 100 when it is opened and closed.

In some embodiments, the white light is coupled to a switch that is activated by the drawer 100 and the colored light is activated by a master switch, master controller, interior lighting switch, or the like. The master switch is disposed, for example, in a cockpit, master control panel, or another location. This may permit a master switch or controller to control a default interior lighting color, aisle lighting color, interior lighting intensity, or the like. The drawer-activated switch may override or change the color of the light so that the white light replaces the interior lighting color when the drawer 100 is opened. In some embodiments, the master switch controls the colored light on the drawer 100 of the seat system 10 and other respective colored lights on respective other drawers 100 of other seat systems 10 also installed in the same aircraft cabin. In various embodiments, each respective white light of each seat system 10 is controlled by a respective switch that is activated by the opening and closing of each respective drawer 100 of each seat system 10.

In some embodiments, the white light is coupled to a first switch and the colored light is coupled to a second switch. The first switch and second switch are coupled to the drawer 100. The first switch and second switch may be pressure sensitive switches that are activated and deactivated by the pressure of the drawer 100 when it is opened and closed. When the drawer 100 is closed, the first switch activates the colored light and the second switch keeps the white light off. When the drawer 100 is open, the first switch keeps the colored light off and the second switch activates the white light. As such, the colored light is on and the white light is off when the drawer 100 is in a closed state, and the colored light is off and the white light is on when the drawer 100 is in an open state. However, any suitable configurations of the light 200, such as including a white light and a colored light, may be used and are within the scope of the disclosed embodiments.

FIG. 1B illustrates a perspective view of a left side of the seat system 10, opposite the perspective view of the right side of the seat system 10 illustrated in FIG. 1A above. The back side of the drawer 100 is visible under the seat base 60. In some embodiments, the back side of the drawer 100 is not covered by a back panel, as the back side of the drawer may face a wall (e.g., an inside wall of an aircraft cabin) and not be visible to a passenger in the seat. In other embodiments, a back panel is present and covers the opening in the seat base 60 to conceal the back side of the drawer 100.

FIG. 1C illustrates a close-up view of the right side of the seat base 60 and the drawer 100. The seat base 60 is coupled to feet 70. In some embodiments, each of the four corners of the seat base 60 is coupled to a respective foot 70, such as by suitable fasteners (e.g., bolts, screws, nuts, washers, the like, or a combination thereof). The feet 70 comprise a suitable material such as aircraft grade aluminum, steel, or the like. The feet 70 may be coupled to a floor (not illustrated), such as a floor of an aircraft cabin, with suitable fasteners.

The drawer 100 is installed on a drawer base 80 (also referred to as a mounting plate) with suitable fasteners 72 (e.g., bolts, screws, nuts, washers, the like, or a combination thereof). In the illustrated embodiments of FIG. 1C, the fasteners 72 are nuts that couple to screws or bolts which mount a frame of the drawer 100 (also referred to as a drawer frame or drawer enclosure) on the drawer base 80. In some embodiments, the drawer base 80 is coupled to the feet 70. Portions of the drawer base 80 (such as rear portions that couple to the feet 70) may extend under the seat base 60. In other embodiments, the drawer base 80 is coupled directly to the floor (e.g., the floor of the aircraft cabin). In some embodiments, the drawer base 80 comprises more than one piece that are coupled together with suitable fasteners. In other embodiments, the drawer base 80 is a single continuous piece formed with a suitable process (e.g., machining, 3D printing, or the like). The drawer base 80 comprises a suitable material such as sheet metal or aircraft grade aluminum. The drawer 100 comprises a suitable mechanism such as two or more slides that allows the drawer box (see below, FIG. 2B) to slide out from under the seat base 60. In some embodiments, a drawer face 110 of the drawer 100 has a shape that conforms to a lower edge of the seat base 60.

FIG. 1D illustrates a close-up view of the left side of the seat base 60 and the drawer 100. In some embodiments, the seat base 60 comprises one or more support structures 64 that are covered by a shroud 62. The support structures 64 are coupled to the feet 70. The back side of the drawer 100 is visible if a back panel is not present.

FIG. 1E illustrates a close-up perspective view of the left side of the seat base 60 and the drawer 100 from below the feet 70 and drawer base 80. The light 200 is installed above the drawer 100 in a face of the shroud 62 that is angled to face and illuminate the drawer 100 in an open state.

FIGS. 2A-2C illustrate various views of the drawer 100 outside of the seat system 10 (see above, FIG. 1A) with the drawer 100 in a closed state and in an open state, in accordance with some embodiments. FIG. 2A illustrates a perspective view of the drawer 100 from above a front right corner of the drawer 100 when the drawer 100 is in a closed state. FIG. 2B illustrates a perspective view of the drawer 100 from above a front right corner of the drawer 100 when the drawer 100 is in an open state. FIG. 2C illustrates a perspective view of the drawer 100 from above the back of the drawer 100 when the drawer 100 is in an open state.

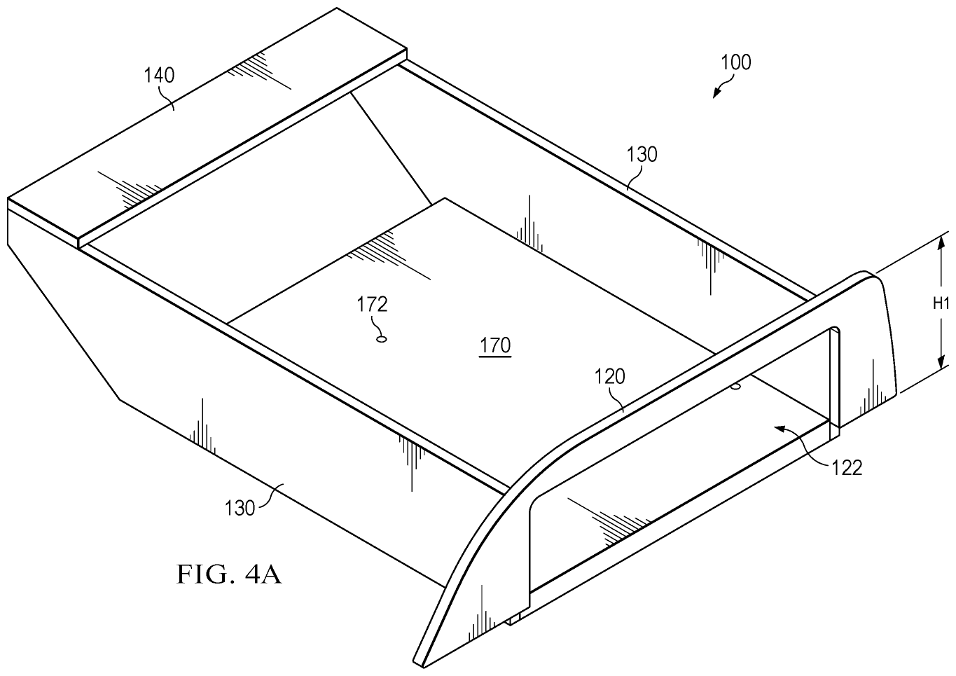

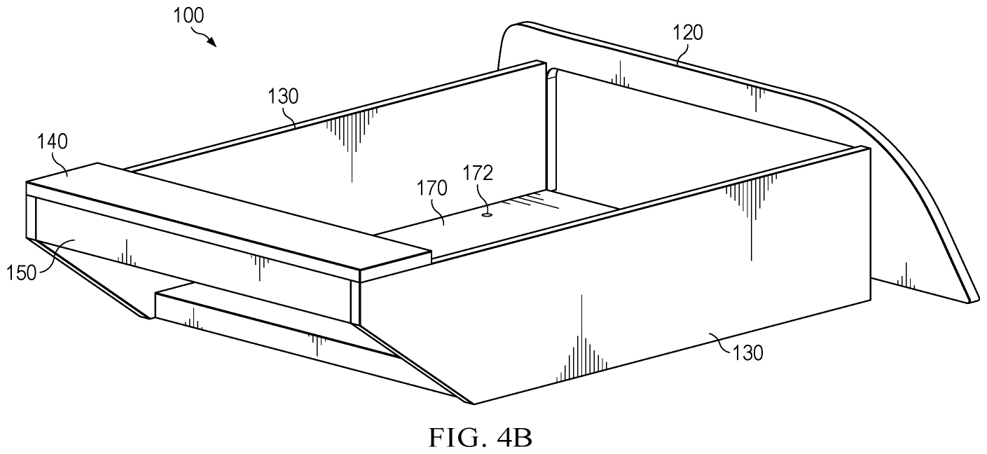

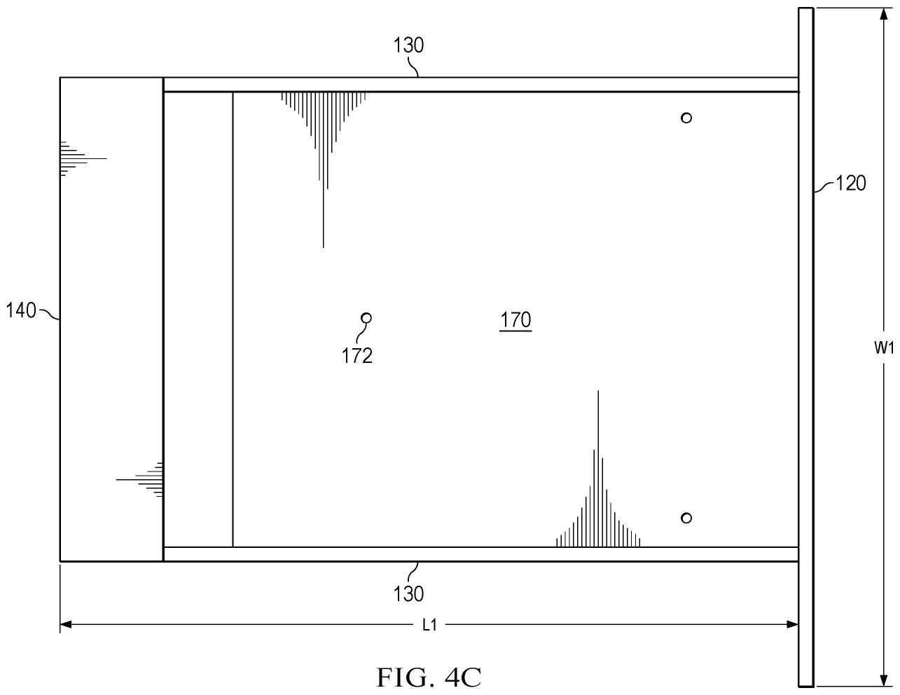

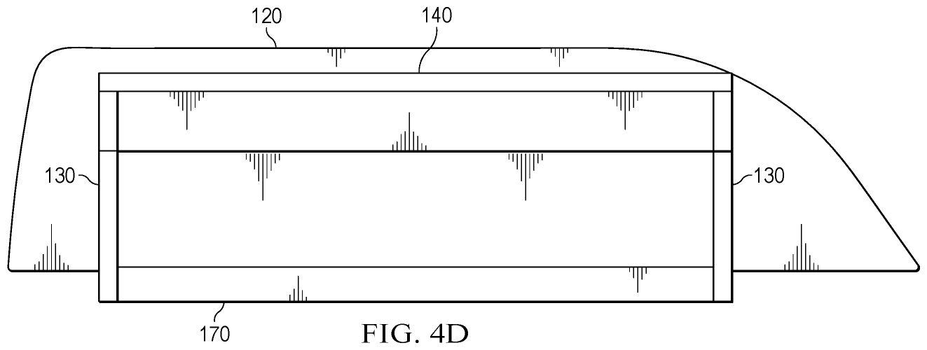

As illustrated by FIGS. 2A-2C, a drawer face 110 (also referred to as a front panel) is mounted on a front face of a drawer box 180. A frame comprising a front frame panel 120, two side frame panels 130, a top frame panel 140, a back frame panel 150, and a bottom frame panel 170 is mounted on the drawer base 80. The drawer box 180 is coupled to the side frame panels 130 by two or more slides 134, which may be coupled to inner sidewalls of the side frame panels 130 and outer sidewalls of the drawer box 180. The slides 134 allow the drawer box 180 to move between a closed state as illustrated by FIG. 2A and an open state as illustrated by FIGS. 2B and 2C. In some embodiments, the slides 134 are ball bearing pullout slides. However, any suitable mechanisms may be used to couple the drawer 100 with the drawer base 80 while allowing it to open and close. The drawer box 180 may slide through a gap in the front frame panel 120 (see below, FIG. 4A). The drawer face 110 may have a plated insert 116 (also referred to as a cover or decorative insert), which may be useful as a place to press on the drawer 100 in order to open and close it.

The drawer box 180 may be used for storage, such as storage of personal items of one or more passengers. In some embodiments, the drawer box 180 comprises four side panels and a bottom panel. The drawer box 180 comprises a suitable material such as plywood, aircraft-grade aluminum, carbon fiber, plastic, the like, or a combination thereof. However, any suitable material may be used to form the drawer box 180.

In some embodiments, the drawer box 180 is uncovered by the top frame panel 140 such that a gap is between a back of the drawer box 180 and an edge of the top frame panel 140. This may be useful for maintaining the structural integrity of the drawer 100 while providing access to the drawer box 180 when the drawer 100 is in an open state.

A push-to-release latch 190 (also referred to as a latch or a mini latch light spring) couples a rear surface of the drawer box 180 with a bottom surface of the top frame panel 140. For example, the push-to-release latch 190 may comprise a hook 192 coupled to the rear surface of the drawer box 180 and a spring portion 194 coupled to the bottom surface of the top frame panel 140, as illustrated by FIG. 2B. The push-to-release latch 190 is operated by applying pressure to the drawer face 110, such as at the plated insert 116. This releases the hook 192 from the spring portion 194 and allows the drawer box 180 to be moved, opening the drawer 100. The hook 192 may lock back into the spring portion 194 and secure the drawer 100 when the drawer 100 is closed.

The front frame panel 120 is coupled to side frame panels 130 and the bottom frame panel 170. In some embodiments, back portions of the side frame panels 130 have chamfered rear bottom corners. The back frame panel 150 is coupled to rear surfaces of the side frame panels 130 above the chamfered rear corners of the side frame panels 130. The top frame panel 140 is coupled to top surfaces of the side frame panels. The various frame panels may be coupled together by suitable fasteners (e.g., pins such as panel pins glued in place, screws, bolts, nuts, washers, the like, or a combination thereof), glue, epoxy, solder, any other suitable fastening method, or a combination thereof, or may be formed as one or more pieces, for example, by stamping, heat forming, molding, or the like. The front frame panel 120, side frame panels 130, top frame panel 140, and back frame panel 150 comprise a suitable material such as sheet metal, aircraft-grade aluminum, carbon fiber, plastic, plywood, the like, laminate such as fiberglass, or a combination thereof. However, any suitable material may be used to form the various panels of the frame.

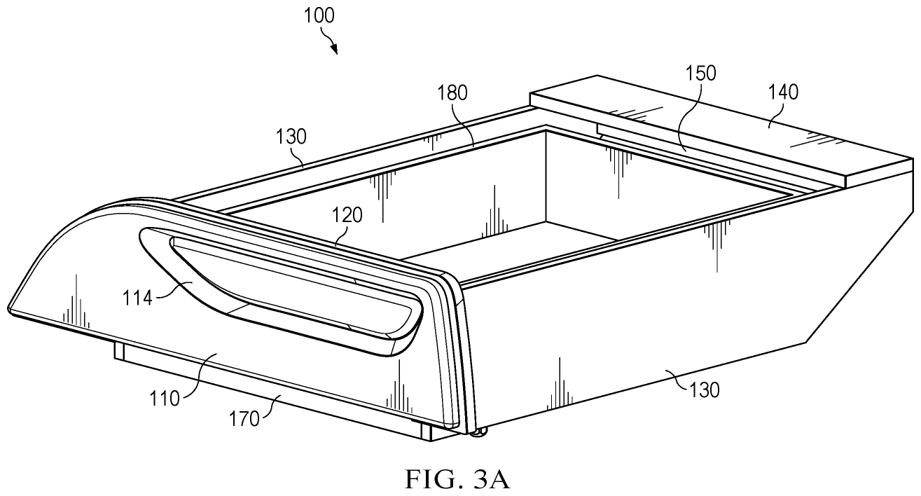

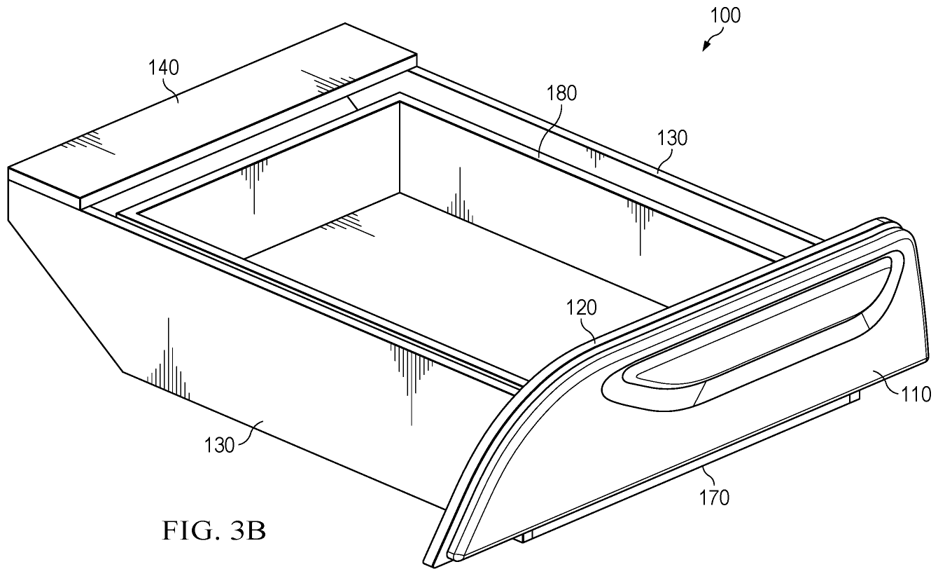

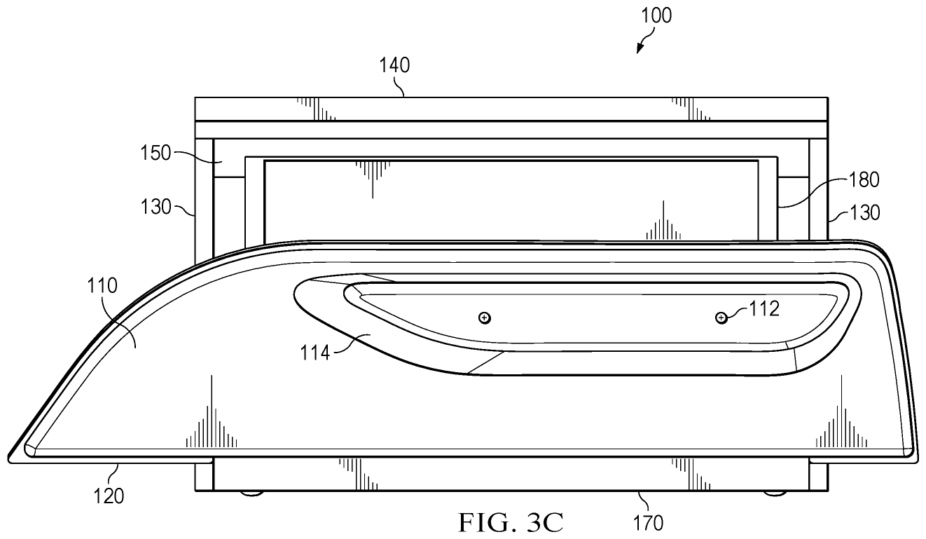

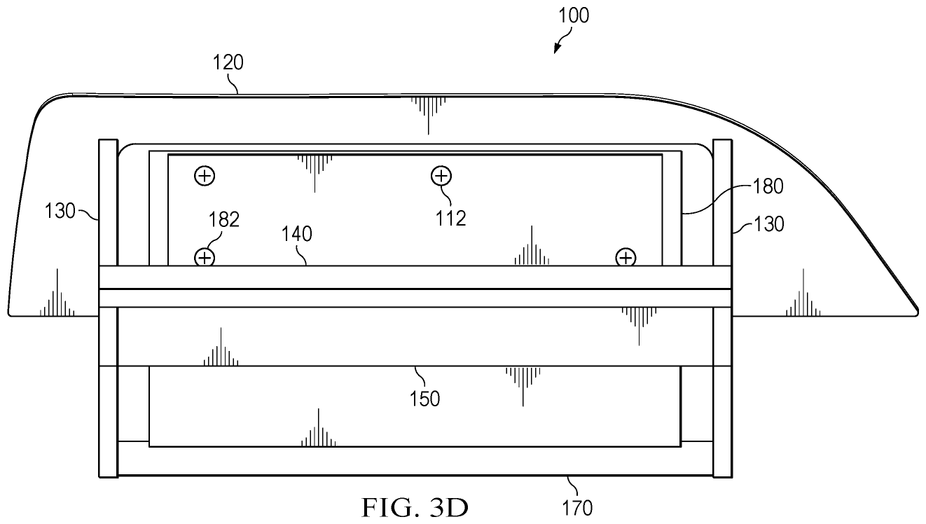

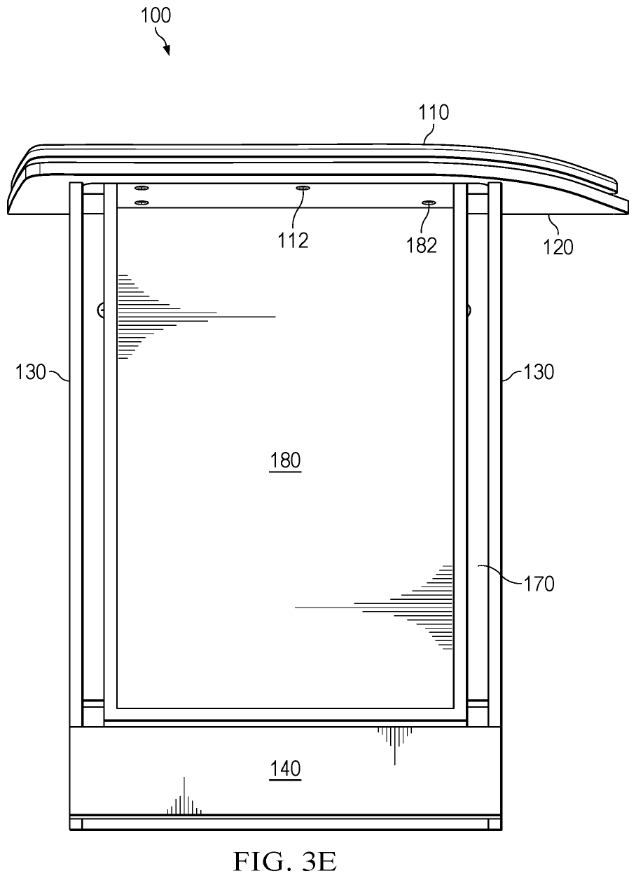

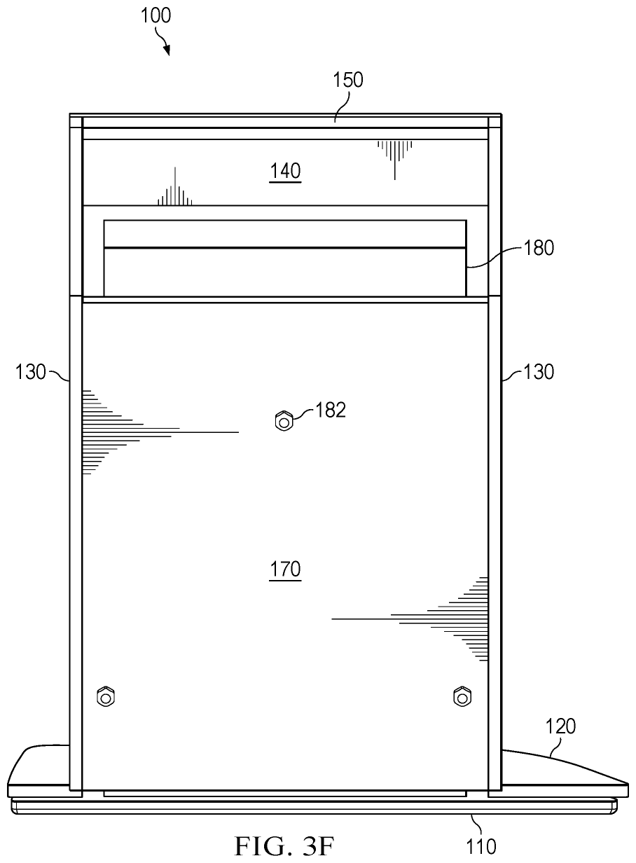

FIGS. 3A-3F illustrate various views of the drawer 100 outside of the seat system 10 (see above, FIG. 1A), in accordance with some embodiments. FIG. 3A illustrates a perspective view of the drawer 100 from above a front right corner of the drawer 100. FIG. 3B illustrates a perspective view of the drawer 100 from above a front left corner of the drawer 100. FIG. 3C illustrates a front perspective view of the drawer 100. FIG. 3D illustrates a back perspective view of the drawer 100. FIG. 3E illustrates a top view of the drawer 100. FIG. 3F illustrates a bottom view of the drawer 100.

As illustrated by FIGS. 3A-3F, the drawer face 110 (also referred to as a front panel) is mounted on a front face of the drawer box 180. The drawer face 110 may be coupled to the drawer box 180 with fasteners 112 and 182 (e.g., screws, bolts, nuts, washers, the like, or a combination thereof). In some embodiments, as illustrated by FIG. 3C, the drawer face 110 has the shape of an irregular trapezoid with rounded top corners. In some embodiments, a bottom left corner of the drawer face 110 comprises a smaller angle than a bottom right corner of the drawer face 110. The drawer face 110 may have a beveled indentation 114. The fasteners 112 may be installed in holes through the beveled indentation 114. In some embodiments, a plated insert 116 (see above, FIG. 2A) is disposed in the indentation 114 and covers the fasteners 112.

FIGS. 4A-4D illustrate various views of the drawer 100 without the drawer face 110 and the drawer box 180 installed (also referred to as the drawer frame or drawer enclosure, in accordance with some embodiments. FIG. 4A illustrates a perspective view of the drawer 100 from above a front left corner of the drawer 100. FIG. 4B illustrates a perspective view of the drawer 100 from above a back left corner of the drawer 100. FIG. 4C illustrates a top view of the drawer 100. FIG. 4D illustrates a back view of the drawer 100.

In some embodiments, the front frame panel 120 has an irregular horseshoe profile around a gap 122, which has a rectangular shape with rounded top corners. The drawer box 180 (see above, FIGS. 3A-3F) may slide through the gap 122 when the drawer 100 is opened or closed. The drawer face 110 (see above, FIGS. 3A-3F) covers the gap 122 when installed, and the drawer box 180 extends through the gap 122 when installed. In some embodiments, the drawer 100 has a height Hi in a range of 2.5 inches to 4.5 inches, a length Li in a range of 13 inches to 15 inches, and a width W1 in a range of 11.5 inches to 13.5 inches.

As illustrated in FIGS. 4A-4C, the bottom frame panel 170 comprises holes 172 that may be used for coupling the bottom frame panel 170 to the drawer base 80 (see above, FIGS. 2A-2C) with suitable fasteners. In some embodiments, the bottom frame panel 170 comprises three holes 172. However, any suitable number of holes 172 may be present.

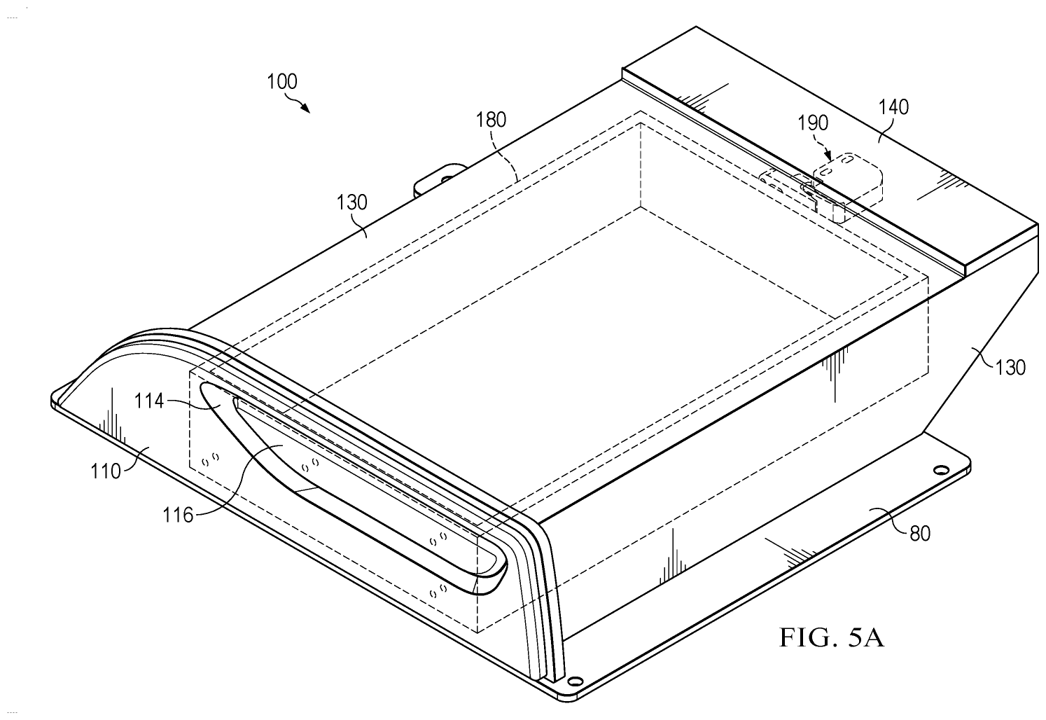

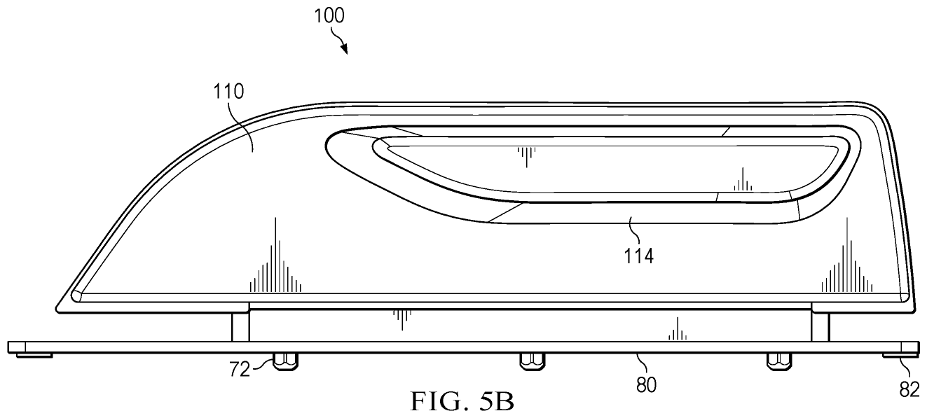

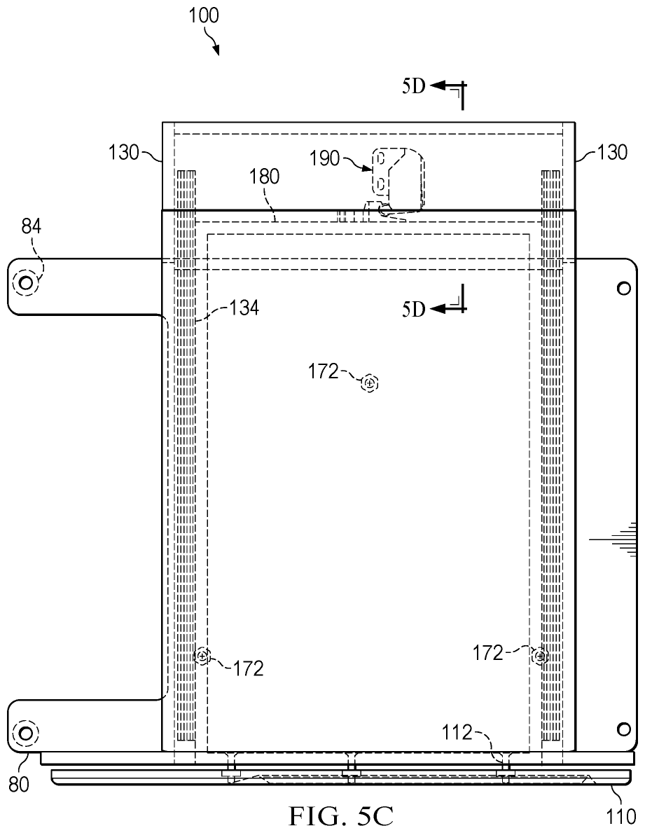

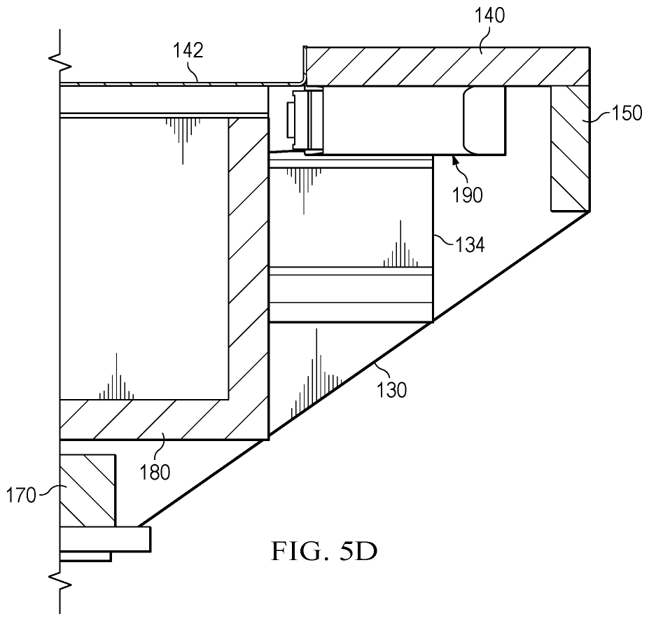

FIGS. 5A-5C illustrate various views of the drawer 100 mounted on the drawer base 80, in accordance with some embodiments. FIG. 5A illustrates a perspective view of the drawer 100 and drawer base 80 from above a front right corner of the drawer 100. FIG. 5B illustrates a front view of the drawer 100 and drawer base 80. FIG. 5C illustrates a top view of the drawer 100 and drawer base 80.

FIG. 5A illustrates the drawer box 180 as dashed lines inside the drawer 100. A push-to-release latch 190 (also referred to as a latch or a mini latch light spring) is installed at a rear surface of the drawer box 180. In some embodiments, the push-to-release latch 190 is coupled to a bottom surface of the top frame panel 140. The push-to-release latch 190 is operated by applying pressure to the drawer face 110, such as at the beveled indentation 114 or plated insert 116. This releases the push-to-release latch 190 and allows the drawer 100 to be opened. The push-to-release latch 190 may lock back into place and secure the drawer 100 when the drawer 100 is closed. In some embodiments, the push-to-release latch 190 comprises a hook 192 and a spring portion 194 (see above, FIG. 2B).

FIG. 5B illustrates the drawer 100 mounted on the drawer base 80. Washers 82 may be coupled to bottom surfaces of the drawer base 80 in order to secure the drawer base to feet 70 (see above, FIGS. 1C-1E).

FIG. 5C illustrates the drawer base 80 having a rectangular shape in a top view with two rectangular protrusions on a left side. The drawer base 80 may be coupled to feet 70 at each of its four corners, such as using holes 84 (located above washers 82; see above, FIG. 5B). Slides 134 couple the drawer box 180 to inner sidewalls of the side frame panels 130. The slides 134 allow the drawer box 180 to move between open and closed states. In some embodiments, the slides 134 are ball bearing pullout slides. However, any suitable mechanisms may be used to couple the drawer 100 with the drawer base 80 while allowing it to open and close.

FIG. 5D illustrates a close-up cross-sectional view of a back portion of the drawer 100 through cross-section 5D-5D as illustrated in FIG. 5C. The push-to-release latch 190 is coupled to an underside of the top frame panel 140. A slide 134 is illustrated as coupled to a side frame panel 130 behind the drawer box 180. In some embodiments, a cover 142 (e.g., a sheet metal cover) is coupled to a sidewall of the top frame panel 140 and to top surfaces of the side frame panels 130. The cover 142 may be useful for preventing any items stored in the drawer box 180 from moving outside of the drawer box 180 and jamming the drawer box 180 in a closed position. The cover 142 may also be advantageous by providing structural integrity for the drawer frame.

FIG. 6 illustrates a flow chart diagram of a method 1000 for storage, in accordance with some embodiments. In step 1002, a drawer face 110 of a drawer 100 is pushed, as described above with respect to FIG. 1A. The drawer 100 is under a passenger seat (e.g., a seat 50). The pushing on the drawer face 110 of the drawer 100 releases a latch (e.g., the push-to-release latch 190).

In step 1004, the drawer 100 is opened and opening the drawer activates a white light (e.g., part of a light 200), as described above with respect to FIG. 1A. The white light is positioned to illuminate the open drawer 100. In step 1006, the drawer 100 is closed and closing the drawer deactivates the white light, as described above with respect to FIG. 1A.

Example embodiments of the disclosure are summarized here. Other embodiments can also be understood from the entirety of the specification as well as the claims filed herein.

Example 1. A system for storage, the system including: a passenger seat, the passenger seat being coupled to a floor of an aircraft; a drawer under the passenger seat, the drawer being configured to open perpendicular to a front side of the passenger seat; and a light coupled to a base of the passenger seat, the light being above the drawer, the light being configured to illuminate an interior of the drawer at a first brightness when the drawer is in an open state and to provide aisle lighting at a second brightness when the drawer is in a closed state, the second brightness being less than the first brightness.

Example 2. The system of example 1, where the drawer includes a push-to-release latch.

Example 3. The system of one of examples 1 or 2, where the drawer includes a drawer face, the drawer face being free of a handle.

Example 4. The system of example 3, where the drawer face has a shape conforming to a lower edge of the base of the passenger seat.

Example 5. The system of example 4, where the base of the passenger seat includes an arch profile with an irregular shape and the drawer face includes a shape of an irregular trapezoid with rounded top corners.

Example 6. The system of one of examples 1 to 5, where the light includes a white light and a colored light.

Example 7. The system of example 6, where the colored light is configured to be on and the white light is configured to be off when the drawer is in the closed state.

Example 8. The system of example 6, where the white light is configured to be on when the drawer is in the closed state.

Example 9. The system of example 8, where the colored light is configured to be on when the drawer is in the closed state.

Example 10. The system of example 8, where the colored light is off when the drawer is in the closed state.

Example 11. A system for underseat storage, the system including: a drawer, the drawer being configured to open with a push, a drawer face of the drawer being free of a handle, the drawer opening in a first direction along two or more slides; a drawer base under the drawer, the drawer being coupled to the drawer base; and an aircraft seat over the drawer, where the aircraft seat faces perpendicular to the first direction, the drawer base being coupled to feet of the aircraft seat.

Example 12. The system of example 11, where the aircraft seat includes a seat base, the drawer being covered by the seat base in a closed state.

Example 13. The system of example 12, where the seat base includes an arch profile with an irregular shape in a side view.

Example 14. The system of example 13, where the seat base further includes a light mounted above the drawer, the light being configured to provide illumination at a first brightness of an aisle next to the aircraft seat.

Example 15. The system of example 14, where the light is further configured to provide illumination at a second brightness of the drawer in an open state, the second brightness being greater than the first brightness.

Example 16. The system of example 15, where the illumination at the first brightness has a first color and the illumination at the second brightness has a second color, the second color being different from the first color.

Example 17. The system of example 16, where the second color is white.

Example 18. A method for storage, the method including: pushing on a drawer face of a drawer, the drawer being under a passenger seat, the pushing releasing a latch; opening the drawer, where opening the drawer activates a white light coupled to a seat base of the passenger seat, the white light being positioned to illuminate the opened drawer; and closing the drawer, where closing the drawer deactivates the white light.

Example 19. The method of example 18, where the passenger seat faces a first direction and the drawer opens in a second direction, the second direction being perpendicular to the first direction.

Example 20. The method of one of examples 18 or 19, where opening the drawer deactivates a colored light and closing the drawer activates the colored light.

Although the disclosure has been described in detail, it should be understood that various changes, substitutions, and alterations may be made without departing from the spirit and scope of this disclosure as defined by the appended claims. The same elements are designated with the same reference numbers in the various figures. Moreover, the scope of the disclosure is not intended to be limited to the particular embodiments described herein, as one of ordinary skill in the art will readily appreciate from this disclosure that processes, machines, manufacture, compositions of matter, means, methods, or steps, presently existing or later to be developed, may perform substantially the same function or achieve substantially the same result as the corresponding embodiments described herein. Accordingly, the appended claims are intended to include within their scope such processes, machines, manufacture, compositions of matter, means, methods, or steps.

What is claimed is:

1. A system for storage, the system comprising:
a passenger seat, the passenger seat being coupled to a floor of an aircraft;
a drawer under the passenger seat, the drawer being configured to open perpendicular to a front side of the passenger seat; and
a light coupled to a base of the passenger seat, the light being above the drawer, the light being configured to illuminate an interior of the drawer at a first brightness when the drawer is in an open state and to provide aisle lighting at a second brightness when the drawer is in a closed state, the second brightness being less than the first brightness.

2. The system of claim 1, wherein the drawer comprises a push-to-release latch.

3. The system of claim 1, wherein the drawer comprises a drawer face, the drawer face being free of a handle.

4. The system of claim 3, wherein the drawer face has a shape conforming to a lower edge of the base of the passenger seat.

5. The system of claim 4, wherein the base of the passenger seat comprises an arch profile with an irregular shape and the drawer face comprises a shape of an irregular trapezoid with rounded top corners.

6. The system of claim 1, wherein the light comprises a white light and a colored light.

7. The system of claim 6, wherein the colored light is configured to be on and the white light is configured to be off when the drawer is in the closed state.

8. The system of claim 6, wherein the white light is configured to be on when the drawer is in the closed state.

9. The system of claim 8, wherein the colored light is configured to be on when the drawer is in the closed state.

10. The system of claim 8, wherein the colored light is off when the drawer is in the closed state.

11. A system for underseat storage, the system comprising:
a drawer, the drawer being configured to open with a push, a drawer face of the drawer being free of a handle, the drawer opening in a first direction along two or more slides;
a drawer base under the drawer, the drawer being coupled to the drawer base; and
an aircraft seat over the drawer, wherein the aircraft seat faces perpendicular to the first direction, the drawer base being coupled to feet of the aircraft seat.

12. The system of claim 11, wherein the aircraft seat comprises a seat base, the drawer being covered by the seat base in a closed state.

13. The system of claim 12, wherein the seat base comprises an arch profile with an irregular shape in a side view.

14. The system of claim 13, wherein the seat base further comprises a light mounted above the drawer, the light being configured to provide illumination at a first brightness of an aisle next to the aircraft seat.

15. The system of claim 14, wherein the light is further configured to provide illumination at a second brightness of the drawer in an open state, the second brightness being greater than the first brightness.

16. The system of claim 15, wherein the illumination at the first brightness has a first color and the illumination at the second brightness has a second color, the second color being different from the first color.

17. The system of claim 16, wherein the second color is white.

18. A method for storage, the method comprising:
pushing on a drawer face of a drawer, the drawer being under a passenger seat, the pushing releasing a latch;
opening the drawer, wherein opening the drawer activates a white light coupled to a seat base of the passenger seat, the white light being positioned to illuminate the opened drawer; and
closing the drawer, wherein closing the drawer deactivates the white light.

19. The method of claim 18, wherein the passenger seat faces a first direction and the drawer opens in a second direction, the second direction being perpendicular to the first direction.

20. The method of claim 18, wherein opening the drawer deactivates a colored light and closing the drawer activates the colored light.
